(19) United States
(12) Patent Application Publication
(10) Pub. No.: US 2005/0253914 A1
(43) Pub. Date: Nov. 17, 2005

(54) Ink jet recording apparatus

(75) Inventor: Takeshi Yokoyama, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Konica Minolta Medical & Graphic, Inc., Tokyo (JP)

(21) Appl. No.: 11/121,714

(22) Filed: May 3, 2005

(30) Foreign Application Priority Data
May 14, 2004 (JP) JP2004-144900

(51) Int. Cl. B41J 2/01

(52) U.S. Cl. 347/102

(57) ABSTRACT

An ink jet recording apparatus comprising recording heads each of which has a nozzle for jetting out light-curing ink which cures when applied to light towards a recording sheet, a light-emitting device equipped with a light source which emits ink-curing light from a luminous tube by discharging at the base, a base temperature controller for controlling the temperature of said base, and a luminous tube temperature controller for controlling the temperature of said luminous tube.

### FIELD OF THE INVENTION

The present invention relates to an image recording apparatus and particularly to an image recording apparatus which uses UV curing ink that cures when exposed to UV light.

### BACKGROUND OF THE INVENTION

Recently, ink jet recording apparatus have been used widely because the apparatus can form images more easily and cheaply than any other printing apparatus such as photogravure and flexographic printing apparatus that require plate-making processes.

In image recording fields that print images on goods and packages by the ink jet recording apparatus, such goods and packages are coated with resin, metal, or materials that do not accept ink easily. To print and fix images on such ink-unacceptable materials, for example, Japanese Non-Examined Patent Publication 2003-145725 discloses an ink jet recording apparatus comprising recording heads each of which has a nozzle to bombard droplets of light-curing ink which cures when exposed to ultraviolet ray or other light and a light emitting device containing a light source which generates light to cure ink, wherein ink droplets are bombarded from nozzles onto a recording medium and light is applied from the light emitting device to the ink on the medium to cure and fix the ink.

If the time interval is great between reach of an ink droplet to the recording medium and application of light to the ink droplet on the recording medium, the ink droplet is sucked into the recording medium and increases the dot size. This may cause blurring or color-mixing and reduce the quality of printout images. To shorten this time interval, the conventional ink jet recording apparatus provides the light emitting device near the recording heads. The light emitting device is equipped with a cover member which covers the light source to prevent light from the light source from reaching the nozzle forming surface of the recording head and curing the ink on the nozzle forming surface.

The ultraviolet ray and other ray emitted from the light emitting device may be harmful to human bodies. To safely use the ink jet recording apparatus equipped with a light emitting device that emits such harmful light indoor such as in an office, an adequate means should be taken to prevent the harmful light from going out of the ink jet recording apparatus. For this purpose, the light emitting device is usually covered with a cover member.

In recent years, cationic hardened ink of the energy storage type has been proposed which cures when exposed long to light of low intensity. A low-power, low-output ultraviolet light source such as a low-pressure mercury lamp and a cold-cathode tube is available to cure the cationic hardened ink.

To get a preset intensity of light required to cure the ink from a low-output type light source, the light emitting device is designed to dispose a plurality of light sources along the movement of the recording medium. Although this light emitting device can apply low-intensity light for a long time to ink dots on the recording medium, the device should preferably be downsized to meet general demands. So it has been proposed to get a preset light intensity by less light sources by supplying stronger power to the light sources and increasing the intensity of illumination per unit time.

However, when the intensity of illumination is increased, the light sources generate more heat. However, the luminous efficiency of a low-output type light source is dependent upon the temperature of the discharging base section of the light source and the temperature difference between the luminous tube and the base section. Accordingly, when the base section and the luminous tube under the cover member become hotter as the light source generates heat, the luminous efficiency of the light source changes and the light source cannot keep on supplying light strong enough to cure the ink. This may deteriorate the image quality.

### SUMMARY OF THE INVENTION

An object of this invention is to provide an ink jet recording apparatus which steadily supplies light strong enough to cure the ink, cures ink preferably, and gets high-quality images.

The ink jet recording apparatus of this invention comprises
recording heads each of which has a nozzle for jetting out light-curing ink which cures when applied to light towards a recording medium,
a light-emitting device equipped with a light source which emits ink-curing light from a luminous tube by discharging at the base,
a base temperature adjuster for adjusting the temperature of said base, and
a luminous tube temperature adjuster for adjusting the temperature of said luminous tube.

This configuration enables independent temperature adjustment of the base section and the luminous tube. So, when the temperature of the base section is adjusted to a temperature at which the luminous efficiency becomes steady and when the difference in temperature between the base section and the luminous tube is so adjusted to stabilize the luminous efficiency of the light source, the ink jet recording apparatus can assure the intensity of illumination optimum for curing the ink.

The ink jet recording apparatus of this invention comprises
a base temperature detector for detecting the temperature of said base, and
a base temperature controller for controlling said base temperature adjuster to keep said base at a preset temperature according to the temperature of said base detected by said base temperature detector.

This configuration enables temperature adjustment of the base section according to the detected temperature and consequently, the temperature of the base section can be adjusted more reliably to a temperature which stabilizes the luminous efficiency of the light source. Namely, the ink jet recording apparatus can assure the intensity of illumination optimum for curing the ink.

The ink jet recording apparatus of this invention comprises
a luminous tube temperature detector for detecting the temperature of said luminous tube, and a luminous tube temperature controller for controlling
said luminous tube temperature adjuster to keep said luminous tube at a preset temperature according to the temperature of the said luminous tube detected by said luminous tube temperature detector.

This configuration enables temperature adjustment of the luminous tube according to the detected temperature and consequently, the difference in temperature between the base section and the luminous tube can be adjusted more reliably to stabilize the luminous efficiency of the light source. Namely, the ink jet recording apparatus can assure the intensity of illumination optimum for curing the ink.

Said light-emitting device is equipped with a reflection member for reflecting diffused light coming from said light source onto said recording medium and said luminous tube temperature adjuster adjusts the temperature of said luminous tube by adjusting the temperature of said reflection member.

This configuration enables direct local temperature adjustment of the luminous tube and prevents local change in the luminous efficiency. Consequently, the temperatures of the base section and the luminous tube can be adjusted to stabilize the luminous efficiency of the light source. Namely, the ink jet recording apparatus can assure the intensity of illumination optimum for curing the ink.

A cover member is provided to cover said light source and said cover contains a partitioning member to separate the base section which contains said base from a luminous tube section which contains said luminous tube.

This configuration separates the base section from the luminous tube section with the partitioning member. This enables independent temperature adjustment of the base section and the luminous tube at a higher precision.

It is preferable that at least one of said base temperature adjuster and said luminous tube temperature adjuster is a cooling fan.

It is preferable that the rotating speed of said cooling fan is variably controlled by temperature.

It is preferable that said cooling fan is variably controlled to run and stop by temperature.

It is preferable that at least one of said base temperature adjuster and said luminous tube temperature adjuster is a Peltier module which variably controls to cool and heat by temperature.

It is preferable that said light source is a low-pressure mercury lamp.

### BRIEF DESCRIPTION OF THE DRAWINGS

FIG. 1 shows a perspective view of an ink jet recording apparatus which is the first embodiment of this invention.

FIG. 2 shows a perspective view showing a carriage and a UV emitting device in the ink jet recording apparatus of FIG. 1.

FIG. 3 shows a perspective top view of the UV emitting device in the ink jet recording apparatus of FIG. 1.

FIG. 4 shows a perspective bottom view of the UV emitting device in the ink jet recording apparatus of FIG. 1.

FIG. 5 shows a perspective rear view of the UV emitting device (viewed from the upstream side in the subsidiary scanning direction) in the ink jet recording apparatus of FIG. 1.

FIG. 6 shows a functional block diagram of the ink jet recording apparatus of FIG. 1.

### BEST MODE FOR CARRYING OUT AN INVENTION

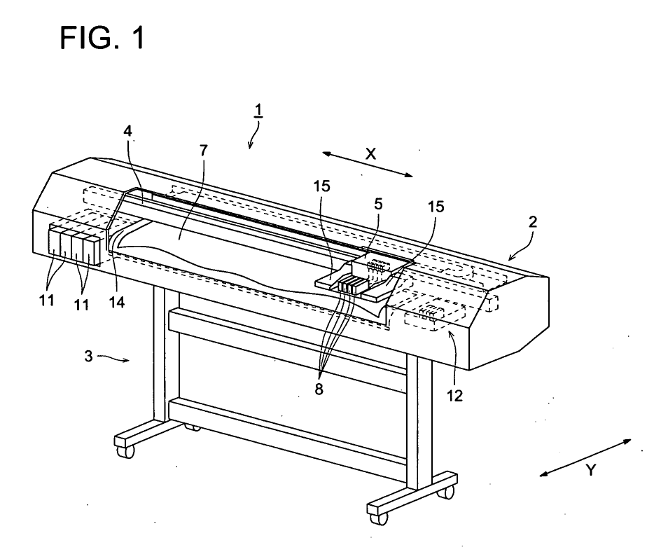

Below will be explained an embodiment of this invention in reference to FIG. 1 to FIG. 6.

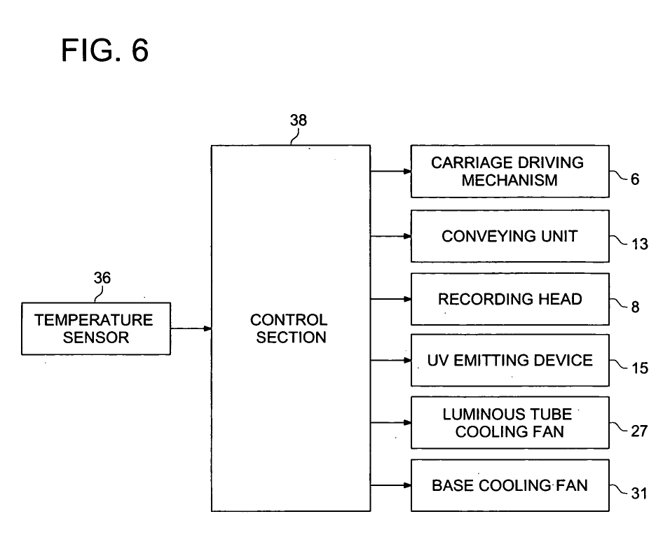

Ink jet recording apparatus 1 of this invention is of the serial-head type and comprises printer body 2 and stand 3 to support printer body 2 as shown in FIG. 1. Printer body 2 contains bar-like guide rail 4 with carriage 5. Carriage driving mechanism 6 (see FIG. 6) drives carriage reciprocally in the main scanning direction along the guide rail 4.

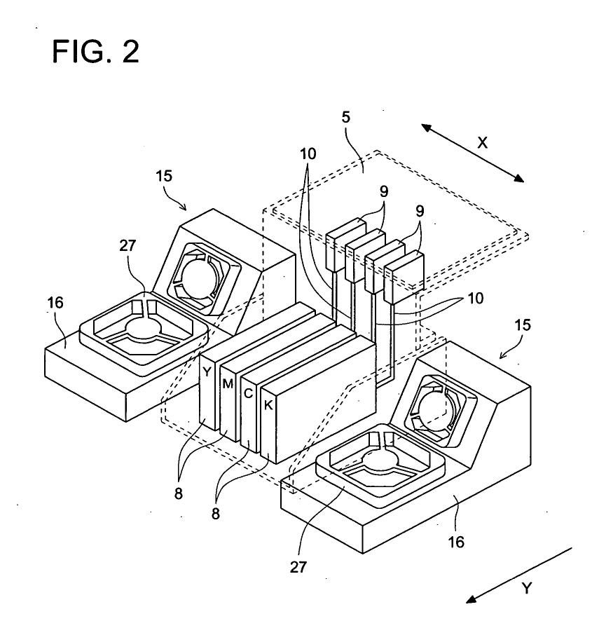

As shown in FIG. 1 and FIG. 2, the carriage 4 contains recording heads 8 having nozzles (not shown in the drawing) which respectively discharge yellow ink (Y), magenta ink (M), cyan ink (C), and black ink (K) to recording medium 7. Recording heads 8 respectively contain intermediate ink tank 9 of the associated ink. Each intermediate ink tank 9 communicates with the associated recording head 8 via the ink supplying pipe 10.

This embodiment uses UV-curing ink which cures when applied to UV light. The UV-curing ink is loosely divided into two: radical polymerization ink containing radical polymeric compound and cationic polymerization ink containing cationic polymeric compound. Energy-storage type cationic polymerization ink is preferable because its polymerization will be less affected by oxygen and it can cure under a long irradiation of low-intensity UV light.

This embodiment can use various types of recording media 7 such as paper sheets (plain paper, recycled paper, and glossy paper), clothes, non-woven clothes, resin sheets, metallic sheets, and glass sheets. Particularly, this embodiment can use, as recording media 7, transparent or opaque unabsorbent resin film for so-called soft wrapping.

The area in the center of the moving range of carriage 5 is a recording area which records images on recording medium 7. Ink supply section 11 is provided on the other outer end of the recording area in the moving range of carriage 5 to feed color inks to intermediate tanks 9 through ink supply channels (not shown in the figure). Maintenance unit 12 is provided in the maintenance area on one outer end of the recording area which is in the moving range of carriage 5.

Printer body 2 is equipped with a conveying mechanism 13 (see FIG. 6) to feed recording medium in subsidiary direction Y which is perpendicular to main scanning direction X. Conveying mechanism 13 contains a motor and rollers (which are not shown in the drawing). The motor drives the rollers to carry recording medium 7 in subsidiary direction Y. During image recording, conveying mechanism 13 repeatedly feeds and stops recording medium 7 to intermittently feed the recording medium 7.

Platen 14 is provided in the recording area under carriage 5 to support recording medium 7 from the back (non-recording side) of the medium). Platen 14 is a flat plate member.

UV-emitting device 15 is provided at each main scanning end of the recording head 8 to emit ultraviolet ray to ink droplets which are jetted from the nozzles to recording medium 7.

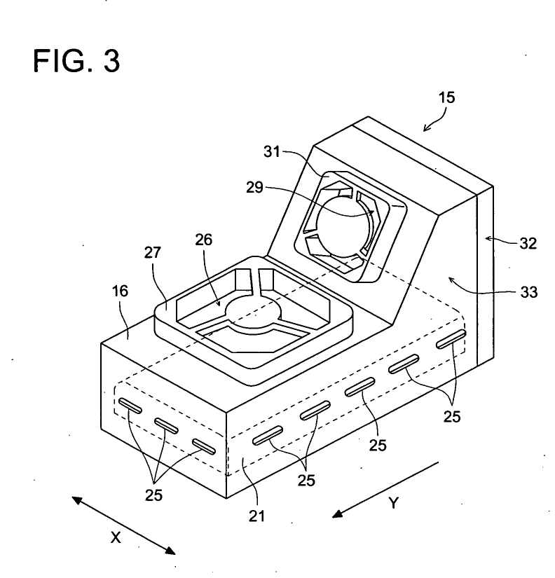

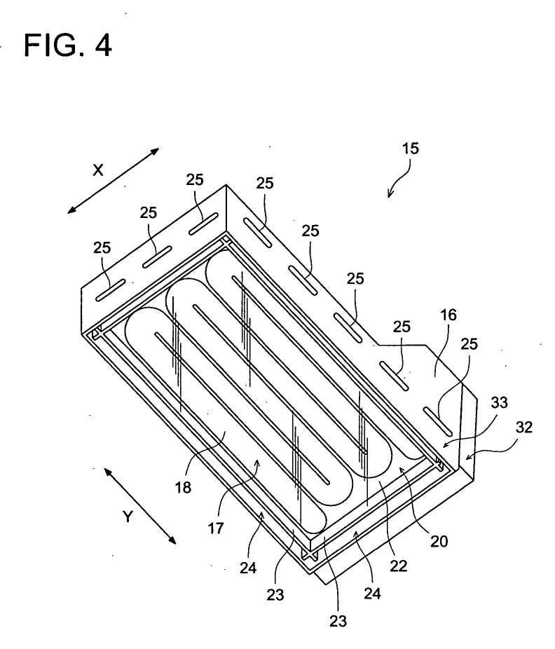

As shown in FIG. 2 and FIG. 3, UV-emitting device 15 is a box which opens towards recording medium 7. The upstream part (in the subsidiary scanning direction Y) of UV-emitting device 15 is covered with upward-projected cover member 16. As shown in FIG. 4, low-pressure mercury lamp 17 as an ultraviolet light source to cure ink is provided under this cover member. Any low-output type light source such as black light, cold cathode tube, etc. can be available besides low-pressure mercury lamp 17.

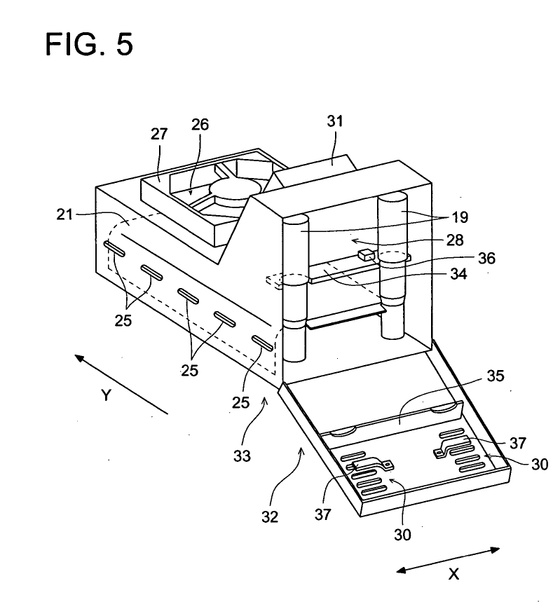

As shown in FIG. 4, low-pressure mercury lamp 17 comprises luminous tube 18 which is folded at preset intervals in subsidiary scanning direction Y and cylindrical base sections 19 (see FIG. 5) which are connected to both ends of luminous tube 18 and extend upwards in the upward-projected cover member (16). Luminous tube 18 turns on to emit light when power is supplied to base section 19. The shape of luminous tube 18 is not limited to what is shown in FIG. 4. For example, the luminous tube is available as long as both ends of the luminous tube fit to base sections 19.

Luminous tube storage section 20 (see FIG. 4) which stores luminous tube 18 under cover member 16 contains reflection member 21 (see FIG. 3) to cover luminous tube 18 and reflect diffused ultraviolet rays from light source 15 to recording medium 7. A high-purity aluminum reflection plate which can reflect ultraviolet rays of all wavelengths efficiently can be used as reflection member 21. Particularly, a preferable reflection member is a cold mirror (glass mold plate) which is made by evaporating a thin film of aluminum-rich metallic compound on a glass surface because it reflects ultraviolet rays efficiently but allows visible light and infrared rays which have no effect on ink curing to pass through the mirror and because it can suppress reduction in luminous efficiency due to heat of the light source.

Protective member 22 is mounted on the bottom of luminous tube storage section to protect light source 9 against contaminants such as ink mist and to prevent lifted recording medium 7 from touching luminous tube 18. Protective member 22 is supported by bar-like supporting members 23 on cover member 16. Supporting member 23 is spaced from the sides of cover member 16 to provide clearance 24 therebetween. Protective member 22 is a flat clear glass or plastic sheet and replaced periodically for maintenance.

Each side of cover member 16 surrounding the luminous tube storage section 20 has a plurality of air intake slots 25 (see FIG. 3 to FIG. 5) to take cold air into luminous tube storage section 20. Cover member 16 above luminous tube storage section 20 has exhaust hole 26 (see FIG. 3 to FIG. 5) on its top to exhaust hot air from inside luminous tube storage section 20. Luminous tube cooling fan 27 is fit to exhaust hole 26 on the top of cover member 16 to take cold air from air intake slots 25 and clearances 24 between supporting members 23 and cover member and fan out the air from exhaust hole 26. With this, the heat of luminous tube 18 is diffused and luminous tube is cooled. In other words, this fan 27 works as a luminous tube temperature adjuster.

The upward-projected part of cover member 16 is base storage section 28 (see FIG. 5) which contains base sections 19. The downstream slanted part (in the subsidiary scanning direction Y) of base storage section 28 has air intake hole 29 to take in cold air into base storage section 28. The upstream end part (in the subsidiary scanning direction Y) of base storage section 28 has a plurality of slits 30 (see FIG. 5) to exhaust hot air from inside of base storage section 28.

Base cooling fan 31 (see FIG. 3 and FIG. 5) is fit to air intake hole 29 on the downstream slanted side of cover member 16 (in the subsidiary scanning direction Y) to take cold air from air intake hole 29 and to fan out hot air through slits 30. With this, the heat of base sections 19 is diffused and base sections 19 are cooled. The rotational speed of base cooling fan 31 can be varied by changing the voltage applied to the motor.

As shown in FIG. 5, the upstream end (in subsidiary scanning direction Y) of cover member 16 works as lid 32 used to mount or demount low-pressure mercury lamp 17 into or from light emitting section 33. Lid 32 can rotate around the bottom side of the lid as the axis. Heat-insulating plate-like partitioning member 34 is provided between luminous tube storage section 20 and base storage section 28 in light emitting section 33 with one edge of partitioning member 34 butted to the downstream side (in subsidiary scanning direction Y) of the luminous tube side of base section 19. Another heat-insulating plate-like partitioning member 35 is provided on lid section 32 to separate luminous tube storage section 20 from base storage section 28 when the lid is closed. Partitioning members 34 and 35 are so disposed as to form a single partitioning member when the lid is closed.

Base temperature sensor 36 is provided on partitioning member 34 near base section 19 as a means to detect the base temperature.

Terminals 37 are provided on the lid section 32 so that the terminals may touch the associated base sections 19 and supply power to base sections 19 when the lid is closed to the light emitting section body 33. When high power is supplied to base sections 19 through these terminals 37, luminous tube 18 turns on and emits ultraviolet rays of high intensities.

FIG. 6 shows a functional block diagram of a control device to control ink jet recording apparatus 1 of this embodiment. This control device contains control section 38 which comprises CPU, RAM, and ROM (which are not shown in the drawing), expands processing programs from ROM to RAM, and causes the CPU to execute the programs.

Control section 38 executes the processing programs to control carriage driving mechanism 6, conveying mechanism 13, recording heads 8, UV emitting device 15, luminous tube cooling fan 27, and base cooling fan 31 according to their operating status and the like.

Particularly, in ink jet recording apparatus 1, base temperature sensor 36 is connected to control section 38. According to the base temperatures detected by base temperature sensor 36, control section 38 controls the rotational speed of base cooling fan 31 to keep base section 19 at a preset temperature.

Since a low-output light source has a characteristic that the energy level of the generated ultraviolet rays is dependent upon the temperature of base sections 19, it is preferable to pre-measure the temperature of base section at a good luminous efficiency and to keep base section 19 at the temperature. The base section temperature which optimizes the luminous efficiency is dependent upon the magnitude of current passing through base section 19. For example, when the output becomes stable and the luminous efficiency is optimum at 40±5° C., control section 38 controls the temperature of base section 19 to 40±5° C. by increasing the speed of base cooling fan 31 if the temperature exceeds 45° C. and decreasing the speed of base cooling fan 31 if the temperature is in the range of 40 to 45° C. (including both).

A preset time later after low-pressure mercury lamp 17 is turned on for recording, control section 38 starts to run luminous tube cooling fan 27. When recording is completed and low-pressure mercury lamp 17 is turned off, control section 38 stops running luminous tube cooling fan 27.

Since a low-output light source like low-pressure mercury lamp 17 has a characteristic that the energy level of the generated ultraviolet rays is also dependent upon the difference in temperature between base sections 19 and luminous tube 18, it is preferable to keep base sections 19 at a temperature which optimizes luminous efficiency, detect an optimum temperature of luminous tube 18 at which the difference of temperatures is optimum for high luminous efficiency, turn on low-pressure mercury lamp 17, wait until the optimum temperature of luminous tube 18 exceeds the high optimum temperature limit, measure this time period, and start to run luminous tube cooling fan 27 after this time period. Generally, the optimum temperature of luminous tube 18 (e.g. low-pressure mercury lamp 17) is in a certain range. Therefore, judging from the temperature rise rate of luminous tube 18, it is necessary to run luminous tube cooling fan 27 at a rotational speed so that the temperature of luminous tube is in the optimum temperature range.

Next will be explained the operation of ink jet recording apparatus 1 which is the embodiment of this invention.

When image recording starts, conveying mechanism 13 feeds recording medium 7 in subsidiary scanning direction Y. When recording medium 7 reaches a preset position of platen 14, carriage 5 reciprocally moves along guide rail 4 while ink droplets are jetted out onto recording medium 7 from nozzles of recording heads 8 according to preset image data. At the same time, low-pressure mercury lamp 17 of UV-emitting device 15 turns on and applies ultraviolet light to ink dots on recording medium 7. The ink dots on recording medium 7 are cured and fixed and thus an image is formed on recording medium 7.

As a high power is applied to base sections 19, base section 19 and luminous tube 18 become hot. Base temperature sensor 36 senses the temperature of base section 19. Control section 38 controls the speed of base cooling fan 31 by the detected temperature to keep base sections 19 at a preset temperature.

A preset time later after the ultraviolet light source is turned on, control section 38 starts to run luminous tube cooling fan 27 to uniformly cool the top surface of reflection member 21. With this, luminous tube 18 is uniformly cooled (without being cooled locally) so that the temperature difference between luminous tube 18 and base section 19 may be in a temperature difference range for efficient luminous efficiency.

In this way, base storage section 28 is separated from luminous tube storage section 20 by a heat-insulating partitioning member and controlled to a temperature which stabilizes luminous efficiency. Further, the temperatures of luminous tube 18 and base sections 19 are controlled so that their difference may be in an optimum temperature range which stabilizes luminous efficiency of low-pressure mercury lamp 17. Therefore, the light emitting device can always generate stable light at high efficiency and apply it to ink dots on recording medium 7.

As already described, ink jet recording apparatus 1 can keep high luminous efficiency and output stable ultraviolet light. Therefore, the ink is cured adequately and we can get good stable images.

Although this embodiment uses speed-variable base cooling fan 31 and controls the speed of the fan according to the temperature of base section 19, it is possible to use a fixed-speed base cooling fan 31 and controls the fan according to the temperature of base sections 19 to run the fan when the base section temperature is high or to stop the fan when the base section temperature is low. Further it is possible to run base cooling fan 31 at a fixed speed during image recording without controlling the fan speed or turning on/off the fan. In this case, judging from the temperature rise rate of base section 19, it is necessary to run base cooling fan 31 at a rotational speed so that the temperature of base section 19 may be stable and in the optimum temperature range for efficient luminous efficiency.

It is also possible to provide a luminous tube temperature sensor near luminous tube 18 as a luminous tube temperature detector to detect the temperature of the tube and control the operation of luminous tube cooling fan 27 to run and stop the cooling fan 27 according to the temperature of luminous tube 18. Further it is possible to use a speed-variable luminous tube cooling fan 27 and cause control section 38, as the luminous tube temperature controller, to control the speed of the luminous tube cooling fan 27 according to the temperature of luminous tube 18. Furthermore, it is possible to provide a reflection member temperature sensor on part of reflection member 21 to detect the temperature of the reflection member and to control the speed of luminous tube cooling fan 27 according to the temperature of reflection member 21.

Although this embodiment uses cooling fans as the base temperature adjuster and the luminous tube temperature adjuster, but the temperature adjuster are not limited to the cooling fans.

For example, it is possible to provide a Peltier module comprising a plurality of thermoelectric refrigerating elements (Peltier elements) which are electrically connected in series on a heat-conductive section which is made of materials of high heat conductivity and covers two base sections 19. When a d.c. current is directly supplied to the Peltier element from a power supply, the Peltier absorbs heat from one side of the element and radiates heat from the other side. It is preferable to switch these heat-absorbing (cooling) and heat-radiating (heating) sides by reversing the current flow. Further, it is preferable to provide a heat sink on the surface opposite to the heat transfer surface of the Peltier surface to radiate heat which is transferred from the cooling side of the element and to provide a cooling fan on the top of the heat sink to radiate heat from the heat sink.

Control section 38 controls the power supply section to keep the temperature of base sections 19 at a preset temperature at which the luminous tube output is stable at a high luminous efficiency. Specifically, when the base section temperature is high, the control section controls the power supply section to flow a d.c current to the Peltier module to cool the module side with which the heat transfer section is in contact, run the cooling fan. When the base section temperature is low, the control section controls the power supply section to flow a d.c current to the Peltier module to heat the module side with which the heat transfer section is in contact.

Similarly, it is possible to place a Peltier module (instead of luminous tube cooling fan 27) on the top of reflection member 21 with a plate-like heat transfer section (made of materials of a high heat conductivity) therebetween and make the Peltier module control heat transfer according to the temperature of luminous tube 18. This first controls the temperature of reflection member 21 and then the temperature of luminous tube 18.

Further it is possible to provide a water jacket in contact with the base section 19 and a water tank to supply cooling water to the water jacket. The temperature of the base section is controlled by the flow rate of water. Similarly, it is possible to provide a water jacket on the top of reflection member 21, control the temperature of the reflection member by flow of water, and thus control the temperature of luminous tube 18.

In this embodiment, part of cover member 16 is projected upwards in the upstream side of subsidiary scanning direction Y so that base sections 19 can go up from both ends of luminous tube 18 in this projected cover member. This projected part of the light emitting device is made the base storage section 28. However, the shape of cover member 16 is not limited to this. For example, the cover member can be a simple box without such a projected part and base section 19 can be provided along the subsidiary scanning direction. Base cooling fan 31 and luminous tube cooling fan 27 are provided on the top of cover member 16 just over the associated storage sections 28 and 20. In this case, base cooling fan 31 as well as luminous tube cooling fan 27 can take cold air from air intake slots 25 (provided on the sides of the cover member 16) and clearances 24 between lamp protecting member 22 (to protect low-pressure mercury lamp 17) and cover member 16 and fan out the hot air from the exhaust hole. The air intake and exhaust flows can be reversed unless the flight of ink droplets from recording heads 8 is affected by air flow.

Further, in this embodiment, control section 38 which controls components of ink jet recording apparatus 1 controls the speed of base cooling fan 31 as the base temperature controller. However, it is possible to provide a microcomputer in the casing of base cooling fan 31 and cause the microcomputer to work as a base temperature controller and control the speed of base cooling fan 31.

Further, this embodiment uses a serial head type ink jet recording apparatus 1 which forms images by jetting ink droplets onto recording medium 7 while reciprocally moving carriage 5 with recording heads 8 in main scanning direction X and moving recording medium 7 in subsidiary scanning direction Y. However, this invention can be applied also to a line-head type ink jet recording apparatus which has a plurality of recording heads 8 disposed along the whole length of the recording medium 7 and forms images by jetting ink onto recording medium 7 while moving the recording medium perpendicularly to the line of recording heads 8.

Although this embodiment uses UV-curing ink for image recording, the type of ink is not limited to this. It can be ink that cures by non-UV light rays such as electronic rays, X rays, visible rays, and infrared rays. In this case, the ink should contain a polymeric compound which polymerizes and cures by non-UV light and a photoinitiator that initiates polymerization of polymeric compounds by non-UV light. When such ink which cures by non-UV light is used, a light source to generate such non-UV light must be provided.

1. An ink jet recording apparatus comprising recording heads each of which has a nozzle for jetting out light-curing ink which cures when applied to light towards a recording sheet,
a light-emitting device equipped with a light source which emits ink-curing light from a luminous tube by discharging at the base,
a base temperature adjuster for adjusting the temperature of said base, and
a luminous tube temperature adjuster for adjusting the temperature of said luminous tube.

2. The ink jet recording apparatus of claim 1, further comprising
a base temperature detector for detecting the temperature of said base, and
a base temperature controller for controlling said base temperature adjuster to keep said base at a preset temperature according to the temperature of said base detected by said base temperature detector.

3. The ink jet recording apparatus of claim 1, further comprising
a luminous tube temperature detector for detecting the temperature of said luminous tube, and
a luminous tube temperature controller for controlling said luminous tube temperature adjuster to keep said luminous tube at a preset temperature according to the temperature of the said luminous tube detected by said luminous tube temperature detector.

4. The ink jet recording apparatus of claim 1, wherein said light-emitting device is equipped with a reflection member for reflecting diffused light coming from said light source onto said recording medium and
said luminous tube temperature adjuster adjusts the temperature of said luminous tube by adjusting the temperature of said reflection member.

5. The ink jet recording apparatus of claim 1, wherein a cover member is provided to cover said light source and said cover contains a partitioning member to separate the base section which contains said base from a luminous tube section which contains said luminous tube.

6. The ink jet recording apparatus of claim 1, wherein at least one of said base temperature adjuster and said luminous tube temperature adjuster is a cooling fan.

7. The ink jet recording apparatus of claim 6, wherein the rotating speed of said cooling fan is variably controlled by temperature.

8. The ink jet recording apparatus of claim 6, wherein said cooling fan is variably controlled to run and stop by temperature.

9. The ink jet recording apparatus of claim 1, wherein at least one of said base temperature adjuster and said luminous tube temperature adjuster is a Peltier module which variably controls to cool the heat by temperature.

10. The ink jet recording apparatus of claim 1, wherein
said light source is a low-pressure mercury lamp.
